(19) United States
(12) Patent Application Publication
(10) Pub. No.: US 2020/0361221 A1
(43) Pub. Date: Nov. 19, 2020

(54) DEVICES AND METHODS FOR RECORDING AND PRINTING INFORMATION

(71) Applicant: Roberto Perez, NewYork, NY (US)

(72) Inventor: Roberto Perez, NewYork, NY (US)

(21) Appl. No.: 16/857,283

(22) Filed: Apr. 24, 2020

Related U.S. Application Data
(60) Provisional application No. 62/848,049, filed on May 15, 2019.

(51) Int. Cl. B41J 3/36; B41J 3/407; B41J 29/393; H05B 45/10; H04W 4/02; H04W 4/80

(52) U.S. Cl. CPC B41J 3/36; B41J 3/4075; H04W 4/80; H05B 45/10; H04W 4/02; B41J 29/393

(57) ABSTRACT

Embodiments of the present disclosure provide electronic devices and methods for recording and printing information. An electronic device includes an input module for receiving at least one input from a user. The at least one input may include at least one of a clock in button press, a clock out button press and a biometric input. The electronic device further includes a GPS module for recording one or more information, such as at least one of a GPS location information, a time, and date, based on the received at least one input. The electronic device furthermore includes a printer configured to print an encrypted code based on the recorded information. The printer may be a Nano printer or a thermal printer. The electronic device may be used for electronic visit verification (EVV).

### TECHNICAL FIELD

The presently disclosed subject matter generally relates to the field of electronically processing information. More particularly, the present disclosure relates to devices, systems, and methods for electronically visit verification by recording and printing information such as geo position (GPS) information, time, date, etc. when a user is visiting a location.

### BACKGROUND

These days many products and service-based companies provide services at a home or a specific location of their clients. For such services that are provided at the home/location of the clients, the companies send their employees at the home/specific location of the clients. For example, courier delivery companies deliver packets/couriers etc. directly at the location of the individuals or the companies. Similarly, many medical service providers may require sending their caretakers, doctors, nurses etc. To the home of the patients. Further, the product companies like a television selling or servicing company may send their employees at a location of a customer who purchased the television for installation or servicing as per the warranty or guarantee. The companies that send their employees for home/location visit etc. may want to track the arrival and departure time of their employees from the specific locations. This may be required to bill the clients/customers and also may be required to pay the employees accordingly. Further, in some countries it may be a legal requirement for logging in arrival and departure time of an employee from a clients'/customers' location for these home/location visits.

Presently, there exist techniques for remotely recording the time of arrival and departure of the employees via a telephone network at various location or work sites. An existing system is based on an automatic number identification technique of an employee. The system detects from a calling employee automatic number identification data and receives at least one personal identification code from the employee. The automatic number (or personal code) identification is used to identify the telephone from which the call is made. This system suffers from limitations as personal identification codes that are manually entered using the calling device (phone etc.) can be entered by any individual. Therefore, mere receipt of the personal identification code may not assure that an authentic person to whom the code was assigned originally has entered it. Further, this system may not work where there is no telephone network.

Alternatively, the employees would use a paper time sheet, call into an EVV Electronic Visit Verification system under the 21^{st} Century Cures Act requirement, or use a cell phone GPS enabled device to authenticate that a visit by the home care attendant was actually done at the place of service or home of the client. This also suffers from the limitation, as it may not work in rural or inner areas where there is no telephone, or mobile network

In light of the above, there exists a need for improved techniques to help users such as employees of the companies to record their arrival and departure time and other information accurately.

### SUMMARY

The present disclosure provides an electronic device and method for recording and printing information such as geo position information, time, date, etc. when a user is visiting a location, such as a client's location, for one or other reason such as for providing one or more service. The electronic device may be a portable handheld device, hence is easy to carry around.

The present disclosure provides electronic devices and methods for recording information such as, but not limiting to, GPS information like latitude and longitude information of a user, time, date etc. In real-time without requiring any cell phone or telephone connectivity.

The present disclosure provides handheld electronic devices for recording information such as, but not limiting to, GPS information like latitude and longitude information of a user, time, date etc. In real time and printing an encrypted code based on the recorded information without requiring any cell phone or telephone connectivity.

An objective of the present disclosure is to provide an electronic device for Electronic Visit Verification (EVV). The electronic device may verify a visit of a user at a location by recording a GPS location including longitude and latitude information of the electronic device based on an input from the user, and then printing an encrypted code with the date, time, and details of the longitude and latitude of the GPS location in real-time. This recorded information and/or the printed information may be used to electronically verify the visit of the user at the location. The electronic device may not require any cell phone/telephone connectivity for recording and printing the information. Further, the electronic device may be a handheld device.

An embodiment of the present disclosure provides an electronic device for recording and printing information. The electronic device includes an input module configured to receive at least one input from a user. The electronic device also includes a GPS (Geo Positioning System) module configured to record information comprising at least one of a GPS location information, a time, and a date based on the received at least one input. The electronic device also includes a printer configured to print the recorded information on an output medium.

According to an aspect of the present disclosure, the at least one input may include at least one of a clock in button press, a clock out button press and a biometric input.

According to another aspect of the present disclosure, the electronic device may also include a biometric scanner configured to: receive the biometric input from the user; and record a GPS location of the electronic device.

According to another aspect of the present disclosure, the electronic device may also include a microcontroller configured to generate an encrypted code based on the recorded information, wherein the printer is configured to print the encrypted code.

According to another aspect of the present disclosure, the electronic device may also include a power management module configured to provide power to the electronic device.

According to another aspect of the present disclosure, the electronic device may also include a one or more indicators configured to output one or more signals to the user, wherein the one or more indicators comprise a light emitting diode (LED) indicator.

According to another aspect of the present disclosure, the electronic device may also include a connection module configured to connect the electronic device with at least one device.

Another embodiment of the present disclosure also provides a handheld electronic device for electronically verifying a visit of a user at a location. The handheld electronic device (hereinafter may also be referred as device without change in its meaning) includes an input module configured to receive at least one input from the user. The device also includes a GPS (Geo Positioning System) module configured to record information comprising at least one of a GPS location information, a time, and a date based on the received at least one input. The device further includes a microcontroller configured to generate and store an encrypted code based on the recorded information.

According to an aspect of the present disclosure, the handheld electronic device also includes a biometric scanner configured to: receive a biometric input from the user; and record a GPS location of the electronic device.

According to an aspect of the present disclosure, the handheld electronic device also includes a printer configured to print the encrypted code on an output medium.

According to an aspect of the present disclosure, the printer is at least one of a Nano printer and a thermal printer.

According to another aspect of the present disclosure, the handheld electronic device may also include a power management module configured to supply power to the electronic device, wherein the power management module comprising at least one battery.

According to another aspect of the present disclosure, the handheld electronic device may also include one or more indicators to output one or more signals to the user, wherein the one or more indicators comprise a light emitting diode (LED) indicator.

According to another aspect of the present disclosure, the handheld electronic device may also include a connection module configured to enable the handheld electronic device to connect with at least one device.

According to another aspect of the present disclosure, the connection module connects the handheld electronic device with the at least one device via Bluetooth.

A yet another embodiment of the present disclosure provides a method for Electronic Visit Verification of a user at a location. The method includes receiving, by an input module, at least one input from a user, wherein the at least one input comprises at least one of a clock in button press, a clock out button press and a biometric input. The method also includes recording, by a GPS module, information comprising at least one of a GPS location information, a time, and a date based on the received at least one input. The method further includes printing, by a printer, the information on an output medium.

According to an aspect of the present disclosure, the method also includes generating, by a microcontroller, an encrypted code based on the recorded information; and printing, by the printer, the encrypted code on the output medium.

According to another aspect of the present disclosure, the method also includes receiving, by a biometric scanner, the biometric input from the user; and recording, by the biometric scanner, a GPS location of the electronic device.

These together with the other aspects of the present disclosure, along with the various features of novelty that characterize the present disclosure, are pointed out with particularity in the present disclosure. For a better understanding of the present disclosure, its operating advantages, and its uses, reference should be made to the accompanying drawings and descriptive matter in which there are illustrated exemplary embodiments of the present disclosure.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 illustrates an exemplary environment where various embodiments of the present disclosure may function;

FIG. 2 is a block diagram illustrating system elements of an exemplary electronic device, in accordance with an embodiment of the present disclosure;

FIGS. 3A-3B illustrates a control circuit board of the electronic device of FIG. 2;

FIG. 4 is a block diagram illustrating system elements of an exemplary electronic device, in accordance with another embodiment of the present disclosure; and

FIG. 5 is a flowchart illustrating a method for electronically verifying a visit of a user, in accordance with an embodiment of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

As used herein, a device or a module may refer to a device or combination of devices that may include hardware, software, firmware, or combination of these. The module may be machine-implemented instructions.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

All numeric values are herein assumed to be modified by the term “about,” whether or not explicitly indicated. The term “about” generally refers to a range of numbers that one of skill in the art would consider equivalent to the recited value (i.e., having the same or substantially the same function or result). In many instances, the terms “about” may include numbers that are rounded to the nearest significant figure. The recitation of numerical ranges by endpoints includes all numbers within that range (e.g., 1 to 5 includes 1, 1.5, 2, 2.75, 3, 3.80, 4, and 5).

The following detailed description should be read with reference to the drawings, in which similar elements in different drawings are identified with the same reference numbers. The drawings, which are not necessarily to scale, depict illustrative embodiments and are not intended to limit the scope of the disclosure.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements and components comprising one unit and elements or components that comprise more than one unit unless specifically stated otherwise.

As used herein, an electronic device refers to a device configured to electronically verify a visit of a user at a particular location based on an input from the user. The electronic device may not require any cellular connectivity or WIFI/network connectivity for Electronic Visit Verification (EVV) of the user. Further, the electronic device may include hardware, software, and combination of these.

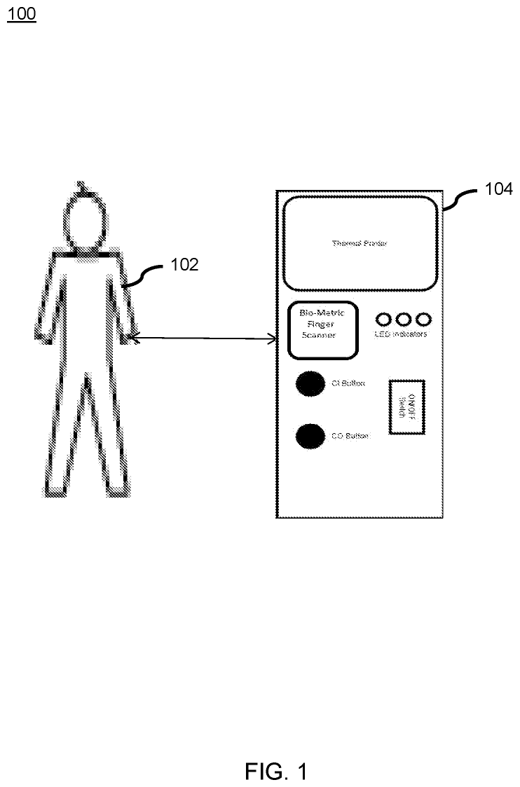

FIG. 1 illustrates an exemplary environment 100 where various embodiments of the present disclosure may function. As shown, the environment 100 includes a user 102 and an electronic device 104. In some embodiments, the user 102 can be any employee of a company or an individual person. The electronic device 104 is a portable handheld device including one or more modules or components. Hereinafter the user 102 may be referred as an employee 102 without change in its meaning. The employee 102 may require visiting home and location of clients/customers or may require to work from work sites away from office. The employee 102 may use the electronic device 104 to clock in his/her arrival time and clock out his/her departure time from the home visit/location visit. This may help the company (or organization) of the employee to keep a record of the employees working hours, payment etc.

The electronic device 104 includes a clock in button, a clock out button, a power on/off button, a printer such as a Nano printer including a thermal printer, one or more indicators, and so forth. The employee 102 may switch on the electronic device by touching or pressing the power on/off button. The employee 102 may use the electronic device 104 for recording clock in and clock out times during a visit to a location or home of the clients. The employee 102 may also use the electronic device 104 for recording log in and log out times while working away from the office. The electronic device 104 is a hardware device that allows employee 102 to clock in and clock out from a location where there is neither cell phone connectivity nor a landline available to authenticate that the employee 102 is at a specific longitude and latitude GPS location at the time they press the Clock in or Clock out Button.

The electronic device 104 primarily has two function: 1. the clock in button which when pressed by the employee 102 on the electronic device 104 or when they enter their finger into the biometric scanner which then logs the GPS location of the electronic device 104 and then the Nano printer prints an encrypted code with the date, time and details of the longitude and latitude GPS location in real time; 2. The clock out button which when pressed by the employee 102 on the electronic device 104 or when the employee 102 enter his/her finger into the biometric scanner which logs the GPS location of the electronic device 104 and then the Nano printer prints an encrypted code with the date, time and details of the longitude and latitude GPS location in real time.

In an exemplary scenario, when the employee 102 arrives at a location of a client or starts work at a location, the employee 102 presses or touches the clock in button. In some embodiments, the electronic device 104 includes a biometric scanner; the employee 102 may touch or enter his/her finger/thumb into the biometric scanner, which then logs the GPS location of the electronic device 104. The electronic device 104 is configured to record one or more information including such as, but not limited to, a GPS location information comprising latitude and longitude information, a time, and a date based on the received at least one input i.e. The clock in button press or finger/thumb biometric input. The electronic device 104 is also configured to generate the encrypted code based on the recorded information and print the encrypted code based on the recorded information on an output medium such as a paper. In some embodiments, the recorded information also includes information about the employee 102 like a user identifier, name, etc.

Similarly, when the employee 102 is departing from the location or ends his/her work at the location of the client may press or touch the clock out button. Alternatively, the employee 102 may touch or enter his/her finger/thumb into the biometric scanner, which then logs the GPS location of the device 104. The electronic device 104 is configured to record one or more information including such as, but not limited to, a GPS location information comprising latitude and longitude information, a time, and a date based on the received at least one input i.e. The clock out button press or finger/thumb biometric input. The electronic device 104 is also configured to generate the encrypted code based on the recorded information and print the encrypted code based on the recorded information on an output medium such as a paper. In some embodiments, the recorded information also includes information about the employee 102 like a user identifier, name, etc. The one or more indicators are configured to output one or more signals to the user 102. For example, the one or more indicators may signal a clock in button press, power on, power off, clock out button press. In some embodiments, the indicators are light emitting diode (LED) indicators. The electronic device 104 may also include Bluetooth.

The electronic device 104 uses a combination of using the GPS with the Nano printer to record information and print the recorded information in an encrypted code sequence of the MM/DD/YYY, HH:MM:SS along with a corresponding barcode printing the location where the electronic device 104 was pressed for a clock in and a clock out. All this occurs without any cell phone connectivity or wires and also does not need to be connected to any other devices.

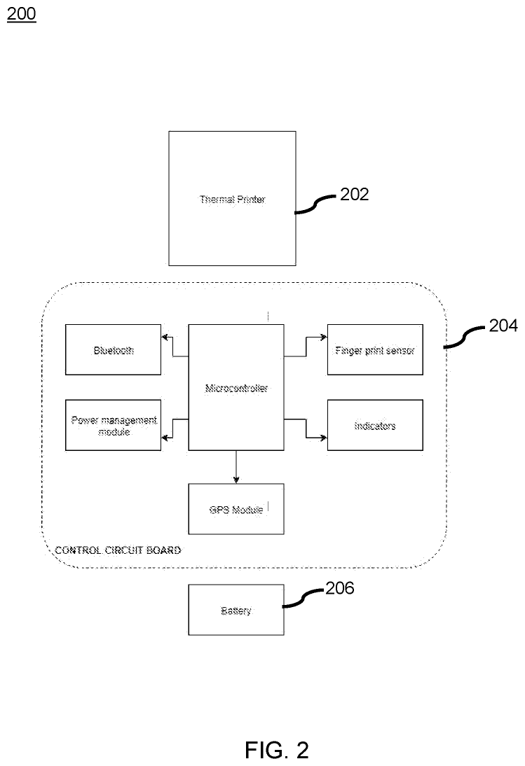

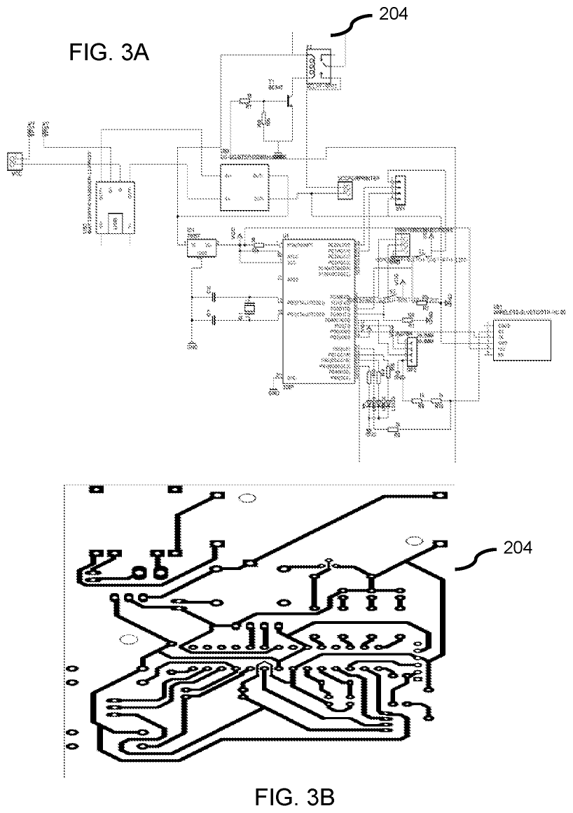

FIG. 2 is a block diagram illustrating system elements of an electronic device 200. The electronic device 200. The electronic device 200 includes an input module comprising a clock in button, a clock out button, and a power on/off button. The electronic device 200 also includes a printer such as a Nano printer or a thermal printer 202, a control circuit board 204, and a battery 206. The control circuit board 204 further includes Bluetooth, a microcontroller, a power management module, one or more indicators, a fingerprint sensor (may also be referred as a biometric scanner/sensor), and a GPS module. The control circuit board 204 may be coupled to the battery 206. The control circuit board 204 is shown in detail in FIGS. 3A-3B.

An employee (or a user), such as the employee 102 as discussed with reference to the FIG. 1, may switch on the electronic device 200 by touching or pressing the power on/off button. The employee 102 may use the electronic device 200 for recording clock in and clock out times during a visit to a location or home of the clients/customers. The employee 102 may also use the electronic device 200 for recording log in and log out times while working away from the office. The electronic device 200 is a hardware device that allows employee 102 to clock in and clock out from a location where there is neither cell phone connectivity nor a landline available to authenticate that the employee 102 is at a specific longitude and latitude GPS location at the time they press the clock in or clock out button.

The electronic device 200 primarily has two function: 1) the clock in button which when pressed by the employee 102 on the electronic device 200 and/or when they enter his/her finger (or thumb) into the biometric scanner which then logs the GPS location of the electronic device 104 and then the Nano/thermal printer 202 prints an encrypted code with the date, time and details of the longitude and latitude GPS location in real time; 2) the clock out button which when pressed by the employee 102 on the electronic device 200 and/or when the employee 102 enter his/her finger into the biometric scanner which logs the GPS location of the electronic device 104 and then the Nano/thermal printer prints an encrypted code with the date, time and details of the longitude and latitude GPS location in real time.

The input module is configured to receive at least one input such as a clock in button press, a clock out button press, a power switch on/off button press, and a finger scan from a user i.e. The employee 102.

The GPS module configured to record one or more information comprising at least one of GPS location information, a time, and date based on the received at least one input. For example, on receiving a clock in press input from the employee 102, the GPS module records the one or more information. The microcontroller configured to generate an encrypted code based on the recorded information. The thermal printer 202 is configured to print the encrypted code based on the recorded information.

The microcontroller is configured to generate an encrypted code based on the recorded information. The one or more indicators are configured to output one or more signals to the user (or the employee 102). The one or more indicators may include light emitting diode (LED) indicators.

The biometric scanner or the finger print sensor is configured to log or record the GPS location of the electronic device 200 when the employee 102 enters his or her finger into the biometric scanner or the finger print sensor.

In some embodiments, the electronic device 200 further includes a micro USB memory card. In some embodiments, the electronic device 200 includes a card slot configured to receive the micro USB memory card.

FIGS. 3A-3B illustrate detailed view of the control circuit board 204 of the electronic device 200 of FIG. 2. The control circuit board 204 shows internal structure of the electronic device 200.

The GPS device (or GPS module) records information, and the printer prints an encrypted code which houses the MM/DD/YYYY, HH: MM: SS and the GPS location based on the recorded information. This printed information may be used to authenticate a valid Electronic Visit Verification (EVV) and that a user was actually at the location where the electronic device 200 was located at time of use for a Clock in or a Clock out. All this may occur without cell phone connectivity or wires and also without any connection to any other devices.

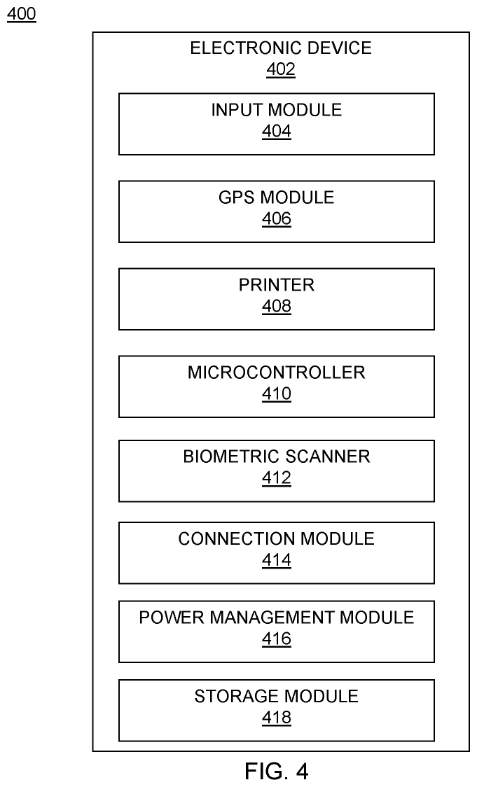

FIG. 4 is a block diagram 400 illustrating system elements of an exemplary electronic device 402, in accordance with another embodiment of the present disclosure.

As shown, the electronic device 402 includes an input module 404, a GPS (Geo Positioning System) module 406, a printer 408, a microcontroller 410, a biometric scanner 412, a connection module 414, a power management module 416, and a storage module 418. The electronic device 402 may be a handheld device.

As discussed with reference to the FIG. 1, the user 102, such as an employee of a company or a service provider, may visit a client's location for providing one or more services. The client's location may be a home, an office, or an outdoor location.

The input module 404 is configured to receive at least one input from the user 102. In some embodiments, the input module 404 may include a clock in button, a clock out button, and a power on and off button. The at least one input may include at least one of a clock in button press, a clock out button press and a biometric input. For example, the user 102 may press/touch the clock in button when the user 102 reaches a particular location, and the user 102 may press/touch the clock out button when the user 102 leaves the particular location.

The GPS module 406 is configured to record information such as, but not limited to, at least one of a GPS location information, a time, and a date based on the received at least one input. The GPS location information is longitude and latitude GPS coordinates about the location the user 102 is present at. The time and date may be the time and date the user 102 provides the input such as the clock in press input.

The printer 408 is configured to print the recorded information on an output medium. The non-limiting examples of the printer 408 may include, but are not limited to, a Nano printer and a thermal printer.

The microcontroller 410 is configured to generate an encrypted code based on the recorded information. The printer 408 may be configured to print the encrypted code on an output medium such as, but not limited to, a paper. This printed information and/or the encrypted code may be used for Electronic Visit Verification (EVV) of the user 102. In some embodiments, the recorded information and/or the encrypted code may be stored in the storage module 418.

The biometric scanner 412 is configured to receive the biometric input from the user 102. Further, the biometric scanner 412 is configured to record a GPS location of the electronic device 202.

The connection module 414 is configured to connect the electronic device 202 with at least one device. In some embodiments, the connection module 414 connects the handheld electronic device with the at least one device via Bluetooth.

The power management module 416 is configured to provide power to the electronic device 402. In some embodiments, the power management module 416 may include at least one battery. The at least one battery may be a solar battery.

The electronic device 402 may help users such as employees of the companies to accurately record their arrival time and departure time and other information on arrival at and departure from a location

Though not shown, but the electronic device 402 may also include one or more indicators configured to output one or more signals to the user 102. In some embodiments, the one or more indicators may include a light emitting diode (LED) indicator.

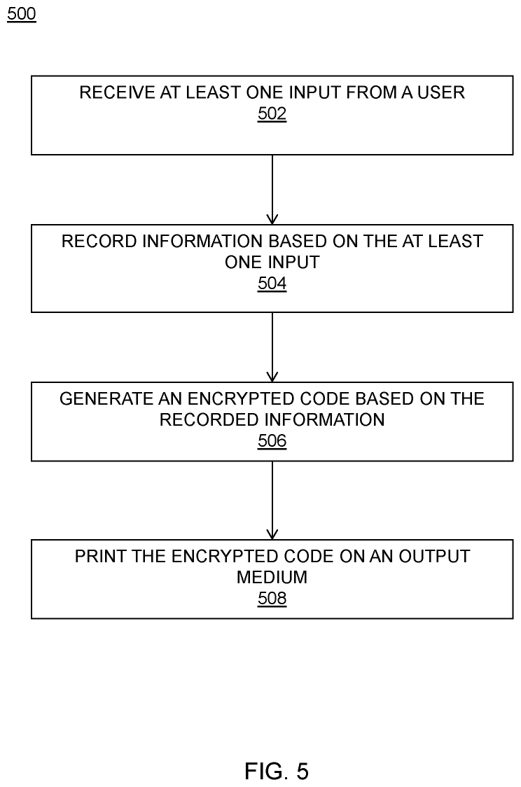

FIG. 5 is a flowchart illustrating a method 500 for electronically verifying a visit of a user by using the electronic device 402 of the FIG. 4, in accordance with an embodiment of the present disclosure. The method 500 initiates at step 502. As discussed with reference to the FIG. 1, the user 102, such as an employee of a company or a service provider, may visit a client's location for providing one or more services. The client's location may be a home, an office, or an outdoor location. Further, the user 102 may provide carry the electronic device 402 and may provide at least one input at the electronic device 402.

At step 502, the electronic device 402 receives at least one input from the user 102. In some embodiments, the input module 404 receives the at least one input from the user 102. In some embodiments, the input module 404 may include a clock in button, a clock out button, and a power on and off button. The at least one input may include at least one of a clock in button press, a clock out button press and a biometric input. For example, the user 102 may press/touch the clock in button when the user 102 reaches a particular location, and the user 102 may press/touch the clock out button when the user 102 leaves the particular location. In some embodiments, the user 102 provides the biometric input such as, but not limited to, a finger scan, a face scan at the biometric scanner 412 of the electronic device 402

At step 504, the electronic device 402 records information based on the at least one input. In some embodiments, the GPS module 406 records the information such as, but not limited to, at least one of a GPS location information, a time, and a date based on the received at least one input.

At step 506, the electronic device 402 generates an encrypted code based on the recorded information. In some embodiments, the microcontroller 410 generates the encrypted code based on the recorded information. The encrypted code and/or the recorded information may be stored in the storage module 418.

Then at step 508, the electronic device 402 prints the encrypted code on an output medium such as a paper. In some embodiments, the printer 408 prints the encrypted code on the output medium i.e. The paper. This printed information may be used for Electronic Visit Verification (EVV) of the user 102.

The disclosed electronic device includes: 1) a clock in button which when pressed by an employee/user on the device or when they enter his/her finger/thumb into the biometric scanner which then logs the GPS location of the device and then the printer prints an encrypted code with a date, time and details of the longitude and latitude of the GPS location in real time; and 2) a clock out button which when pressed by the employee the device or when they enter their finger into the biometric scanner which logs the GPS location of the device and then the Nano printer prints an encrypted code with the date, time and details of the longitude and latitude of the GPS location in real time.

The disclosed electronic device may be used to accurately capture the attendance of the employees working away from office such as from work sites, client's locations, home, etc. In real-time. According to another aspect of the present disclosure, the handheld electronic device further includes a micro USB memory card. In some embodiments, the handheld electronic device includes a card slot configured to receive the micro USB memory card.

The disclosed electronic device may be a handheld electronic device and is configured to authenticate a presence of a user at a particular location by recording information such as time, date, GPS location, etc. In real time on receiving an input such as a clock in and/or clock out button press/touch.

The disclosed electronic device is used by a user for recording GPS location information and time etc. during a home visit to a location of a client. The electronic device does not require any cell phone/telephone connectivity for recording and printing the information. Therefore, the electronic device will work in areas where there is no landline, cell phone connectivity at the location of the client.

The disclosed electronic device may be used for managing attendance of employees working outside the office or of field (or onsite) workers.

The disclosed electronic device enables a user such as an employee to press a clock in button on the electronic device and/or enter his/her finger into an associated biometric scanner. The electronic device may then log a GPS location of the electronic device (i.e. of the user) and then an associated printer of the electronic device may print an encrypted code with a date, time and details of the longitude and latitude GPS location in real time.

Further, the disclosed electronic device may enable the user to press a clock out button on the electronic device and/or enable the user to enter his/her finger into an associated biometric scanner. The electronic device may log a GPS location of the electronic device (i.e. of the user) and then an associated printer of the electronic device such as, but not limited to, a Nano printer prints an encrypted code with a date, time and details of the longitude and latitude GPS location in real time. The printed information may be used for electronically verifying a visit of the user at the location.

The disclosed electronic device is compact and easy to carry. Further, the electronic device may be used to electronically verify visit (EVV) of an employee at a particular location like home of a client during a home visit. The electronic device is configured to capture accurate GPS and time related information when the employee presses clock in button on arrival at the location or at start of the service and when the employee presses a clock out button on departure from the location or at end of the service.

The disclosed electronic device captures clock in and clock out information accurately. The electronic device may record and print the information on an output medium or may present the information to the first user. In some embodiments, the electronic device may generate an encrypted code based on the recorded information and store and/or print the encrypted code.

In the Electronic Visit Verification 21st Century Cures Act requirement, there are only devices like Cell Phones, Cell Phone GPS, Landline Calling and VPN Key devices that are used to authenticate home visits for the home attendant industry currently. None of these have a way of capturing and electronic verify visit (EVV) with a real time printer when there is no cell phone signal, Internet, or landline available at the visit location. The disclosed device may be used for EVV by the service industries, Home Care Agencies, and so forth, which service clients in rural areas when the client has no landline, nor have cell phone or Internet connectivity at the place of service.

The present disclosure provides a method for recording GPS location including longitude and latitude information of an electronic device and then printing an encrypted code with the date, time, and details of the longitude and latitude of the GPS location in real-time. The encrypted code may be stored in the electronic device. The electronic device may not require any cell phone/telephone connectivity for recording and printing the information.

The present disclosure provides an electronic device for recording and printing information such as, time, date, GPS location, etc. In real time on receiving at least one input from a user of the electronic device.

The present disclosure provides a method for using the electronic device for recording and printing information such as, time, date, GPS location, etc. In real time on receiving at least one input from a user of the electronic device.

The present disclosure provides an electronic device configured to record the information such as time, date, GPS location, etc. In real time when a user presses a clock in button of the electronic device. A Nano printer of the electronic device then prints an encrypted code with the date, time, and details of the longitude and latitude of the GPS location based on the recorded information in real time when the clock in button is pressed.

The electronic device is also configured to record information such as time, date, GPS location, etc. In real time when a user presses a clock out button of the electronic device. The Nano printer of the electronic device then again prints an encrypted code with the date, time, and details of the longitude and latitude of the GPS location based on the recorded information in real time when the clock out button is pressed/touched.

The present disclosure provides an electronic device that is configured to use GPS with a Nano printer to print details, encrypted code sequences along with a corresponding barcode printing the location the device on receiving an input when a user presses a clock in button and a clock out button on the electronic device. All this occurs without cell phone connectivity or wires connecting to any other devices with exception to the GPS device.

The present disclosure provides an electronic device that is configured to authenticate a presence of a user at a particular location by recording information such as time, date, GPS location, etc. in real time on receiving an input such as a clock in and/or clock out button press.

The present disclosure provides an electronic device including a GPS, Bluetooth, a circuit board and a printer. The electronic device also includes a clock in button, a clock out button, one or more LED indicators, and a power on and off button.

In some embodiments of the present disclosure, the electronic device is used by a user for recording GPS location information and time etc. during a home visit to a location of a client. The electronic device does not require any cell phone/telephone connectivity for recording and printing the information. Therefore, the electronic device will work in areas where there is no landline, cell phone connectivity at the location of the client.

An embodiment of the present disclosure provides an electronic device for recording and printing information. The electronic device includes an input module configured to receive at least one input from a user. The electronic device further includes a GPS module configured to record one or more information comprising at least one of a GPS location information, a time, and date based on the received at least one input. The electronic device furthermore includes a printer configured to print an encrypted code based on the recorded information. The printer may be a Nano printer.

In some embodiments of the present disclosure, the at least one input comprises a clock in button press, and a clock out button press.

In some embodiments of the present disclosure, the handheld electronic device further includes a micro USB memory card. In some embodiments, the handheld electronic device includes a card slot configured to receive the micro USB memory card.

In some embodiments of the present disclosure, the handheld electronic device further includes a biometric scanner, wherein an employee or a user enters his or her finger into the biometric scanner, which logs the GPS location of the handheld electronic device.

In some embodiments of the present disclosure, the electronic device further includes a power management module configured to provide power to the electronic device.

In some embodiments of the present disclosure, the electronic device further includes one or more indicators to output one or more signals to the user, wherein the indicators comprising light emitting diode (LED) indicators.

In some embodiments of the present disclosure, the electronic device further includes Bluetooth.

In some embodiments of the present disclosure, the electronic device is a portable handheld device that is easy to carry.

In some embodiments of the present disclosure, the printer is a thermal printer.

In some embodiments of the present disclosure, the user presses or touches the clock in or clock out button on the device, which logs the GPS location of the electronic device.

In some embodiments of the present disclosure, the electronic device includes a biometric scanner, wherein the employee or the user enters his or her finger into the biometric scanner, which logs the GPS location of the device.

In some embodiments of the present disclosure provides a handheld electronic device for recording and printing information. The device includes an input module configured to receive at least one input from a user, wherein the at least one input comprises a clock in button press, and a clock out button press; a GPS module configured to record one or more information comprising at least one of a GPS location information, a time, and date based on the received at least one input; a microcontroller configured to generate an encrypted code based on the recorded information; and a thermal printer configured to print the encrypted code on an output medium.

In some embodiments of the present disclosure, the input module comprises a clock in button, a clock out button, and a power on and off button.

In some embodiments of the present disclosure, the indicators include light emitting diode (LED) indicators.

A yet another embodiment of the present disclosure provides a method for recording and printing information. The method includes receiving at least one input from a user, wherein the at least one input comprises a clock in button press, and a clock out button press. The method also includes recording one or more information comprising at least one of a GPS location information, a time, and date based on the received at least one input. The method further includes generating an encrypted code based on the recorded information. The method furthermore includes printing the encrypted code on an output medium.

The present disclosure also provides an Electronic Visit Verification (EVV) system for verifying a visit of a user electronically. The electronic visit verification system includes an input module configured to receive at least one input from the user. The input may include a button press such as, but not limited to, a clock in button press and a clock out button press. The electronic visit verification system may also include a GPS (Geo Positioning System) module configured to record information comprising at least one of a GPS location information, a time, and date based on the received at least one input. Further, the electronic visit verification system includes a microcontroller configured to generate an encrypted code based on the recorded information. In some embodiments, the electronic visit verification system also includes a printer configured to print the encrypted code on an output medium. In an example, the printer may be a thermal printer or a Nano printer. In some embodiments, the electronic visit verification system also includes a power management module configured to supply power to the electronic device. In some embodiments, the electronic visit verification system also includes one or more indicators to output one or more signals to the user. The indicators may include a light emitting diode (LED) indicator.

In some embodiments, the EVV system may be included in an electronic device.

In some embodiments, the electronic visit verification system includes a biometric scanner configured to log or record the GPS location of the handheld electronic device when the user enters his or her finger into the biometric scanner.

In some embodiments, the electronic visit verification system includes a connection module configured to enable the electronic visit verification system to connect with at least one electronic device.

In some embodiments, the input module of the electronic visit verification system may include a clock in button, a clock out button, and a power on and off button.

Method claims set forth below having steps that are designated by letters or numbered should not be considered to be necessarily limited to the particular order in which the steps are recited.

Embodiments of the disclosure are also described above with reference to flowchart illustrations and/or block diagrams of methods and systems. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks. These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flowchart and/or block diagram block or blocks.

In addition, methods and functions described herein are not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

While the invention has been described in connection with what is presently considered to be the most practical and various embodiments, it is to be understood that the invention is not to be limited to the disclosed embodiments, but on the contrary, is intended to cover various modifications and equivalent arrangements.

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the following claims and their equivalents.

What is claimed is:

1. An electronic device for recording and printing information, comprising:
an input module configured to receive at least one input from a user;
a GPS (Geo Positioning System) module configured to record information comprising at least one of a GPS location information, a time, and a date based on the received at least one input; and
a printer configured to print the recorded information on an output medium.

2. The electronic device of claim 1, wherein the at least one input comprises at least one of a clock in button press, a clock out button press and a biometric input.

3. The electronic device of claim 2 further comprising a biometric scanner configured to:
receive the biometric input from the user; and
record a GPS location of the electronic device.

4. The electronic device of claim 1 further comprising a microcontroller configured to generate an encrypted code based on the recorded information, wherein the printer is configured to print the encrypted code.

5. The electronic device of claim 1 further comprising a power management module configured to provide power to the electronic device.

6. The electronic device of claim 1 further comprising one or more indicators configured to output one or more signals to the user, wherein the one or more indicators comprise a light emitting diode (LED) indicator.

7. The electronic device of claim 1 further comprising a connection module configured to connect the electronic device with at least one device.

8. A handheld electronic device for electronically verifying a visit of a user at a location, comprising:
an input module configured to receive at least one input from the user;
a GPS (Geo Positioning System) module configured to record information comprising at least one of a GPS location information, a time, and a date based on the received at least one input; and
a microcontroller configured to generate and store an encrypted code based on the recorded information.

9. The handheld electronic device of claim 8, wherein the input module comprises a clock in button, a clock out button, and a power on and off button.

10. The handheld electronic device of claim 9, wherein the at least one input comprises at least one of a clock in button press, a clock out button press, and a biometric input.

11. The handheld electronic device of claim 10 further comprising a biometric scanner configured to:
receive the biometric input from the user; and
record a GPS location of the electronic device.

12. The handheld electronic device of claim 8 further comprising a printer configured to print the encrypted code on an output medium.

13. The handheld electronic device of claim 12, wherein the printer is at least one of a Nano printer and a thermal printer.

14. The handheld electronic device of claim 8 further comprising a power management module configured to supply power to the electronic device, wherein the power management module comprising at least one battery.

15. The handheld electronic device of claim 8 further comprising one or more indicators to output one or more signals to the user, wherein the one or more indicators comprise a light emitting diode (LED) indicator.

16. The handheld electronic device of claim 8 further comprising a connection module configured to enable the handheld electronic device to connect with at least one device.

17. The handheld electronic device of claim 16, wherein the connection module connects the handheld electronic device with the at least one device via Bluetooth.

18. A method for electronic visit verification of a user at a location, comprising:
receiving, by an input module, at least one input from a user, wherein the at least one input comprises at least one of a clock in button press, a clock out button press and a biometric input;
recording, by a GPS (Geo Positioning System) module, information comprising at least one of a GPS location information, a time, and a date based on the received at least one input; and
printing, by a printer, the information on an output medium.

19. The method of claim 18 further comprising:
generating, by a microcontroller, an encrypted code based on the recorded information; and
printing, by the printer, the encrypted code on the output medium.

20. The method of claim 18 further comprising:
receiving, by a biometric scanner, the biometric input from the user; and
recording, by the biometric scanner, a GPS location of the electronic device.
